(19) United States
(12) Patent Application Publication
(10) Pub. No.: US 2010/0095118 A1
(43) Pub. Date: Apr. 15, 2010

(54) CRYPTOGRAPHIC KEY MANAGEMENT SYSTEM FACILITATING SECURE ACCESS OF DATA PORTIONS TO CORRESPONDING GROUPS OF USERS

(75) Inventor: Anil Kumar Meka, Hyderabad (IN)

Correspondence Address: LAW FIRM OF NAREN THAPPETA, C/O LANDON IP, INC., 1725 Jamieson Avenue, ALEXANDRIA, VA, 22314, US

(73) Assignee: RSA Security Inc., Bedford, MA (US)

(21) Appl. No.: 12/443,823

(22) PCT Filed: Oct. 11, 2007
(86) PCT No.: PCT/US07/81018

§ 371 Date: Mar. 31, 2009

Related U.S. Application Data
(60) Provisional application No. 60/767,588, filed on Oct. 12, 2006.

(51) Int. Cl. H04L 9/32; H04L 9/08

(52) U.S. Cl. 713/168; 380/259; 380/282

(57) ABSTRACT

Cryptographic Key Management System facilitating secure access of data portions to corresponding groups of users. In an embodiment, corresponding group key (asymmetric key pair) is provided for each group, with the private key being stored in a secure format requiring the user credentials for decryption. In addition, a data key required to decrypt a data portion of interest is encrypted using the group public key. Thus, when a user attempts to access a data portion, the user credentials are used to decrypt the group private key, which is then used to decrypt the data key. The data key is then used to decrypt the data portion of interest.

### RELATED APPLICATIONS

The present application is related to and claims priority from PCT application entitled, “Cryptographic Key Management System Facilitatingsecure Access Of Data Portions To Corresponding Groups Of Users” Serial Number: PCT/US07/081018 filed on Oct. 11, 2007, Applicant: RSA Security Inc, naming the same inventors, which in turn claims priority from U.S. Provisional Patent Application entitled, “A Flexible Cryptographic Key Management System” Ser. No. 60/767,588 filed on Oct. 12, 2006, naming the same inventors as in the present application, which are both incorporated in their entirety herewith.

### BACKGROUND

1. Field of the Invention

The present invention relates generally to cryptography and more specifically to a cryptographic key management system facilitating controlled access of data portions to corresponding groups of users.

2. Related Art

Cryptography generally refers to a technique of representing information such that the information content or meaning is not readily apparent to an entity (person or system) gaining access to the represented information. For example, information such as file data may be encrypted using cryptographic techniques, and made accessible in decrypted form only to authorized entities (users or systems) to ensure data security and prevent unauthorized access.

Keys are fundamental to the operation of cryptography. A key generally refers to data which is used by an encryption approach (commonly referred to as an “algorithm” in the relevant arts) as an input in encrypting original data to generate cipher data, and by a corresponding decryption approach while decrypting the cipher data to generate the original data. A key is referred to as an encryption key when used for encryption and as a decryption key when used for decryption.

The keys may be provided only to specific parties to potentially control both encryption and decryption. For example, data of interest may be saved in encrypted form and the decryption key may be provided only to specific users, who are permitted to access the underlying original data. Thus, only users having the decryption key may (easily) decrypt the data and thus have access to the data of interest in the unencrypted form.

There is a general need in the industry to control access of specific data portions to only specific corresponding groups of data. For example, an enterprise may store data related to employees and sales. It may be desirable to provide access (read, write, modify, and/or delete, etc.) of data related to sales only to sales personnel and data related to employees to only human resources department.

It is generally desirable that the cryptography based techniques of above be used for providing such groups based access control as well.

### BRIEF DESCRIPTION OF THE DRAWINGS

The present invention will be described with reference to the following accompanying drawings, which are described briefly below.

FIG. 1 is a block diagram illustrating the details of an example environment in which various aspects of the present invention may be implemented.

FIG. 2 is a block diagram illustrating key hierarchy in an embodiment of the present invention.

FIG. 3 is a flow diagram illustrating the use of various keys in an embodiment of the present invention.

FIG. 4 is a flowchart illustrating the manner in which various keys are generated in an embodiment of the present invention.

FIG. 5 is a block diagram illustrating archival and recovery of data keys in an embodiment of the present invention.

FIG. 6 is a block diagram of an implementation of the present invention in one embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

1. Overview

An aspect of the present invention provides decryption keys (“group key”) for each group of interest. Each portion of the original data is encrypted such that a corresponding “data key” is required for decryption, and the data key is provided in an encrypted form such that a group key is required for decrypting the encrypted data representing the data key. The group key in turn is provided in an encrypted format to each user.

Due to such multiple levels of encryption, group level access control can be enforced in a secure manner.

In the description below, when an element (data portion or keys) is processed according to an encryption approach the resulting secure data is said be in encrypted form. When the secure data is processed to recover the element in original form, the element is referred to as being in unencrypted/decrypted form.

According to another aspect of the present invention, an administrator may control which specific users are placed in which group, and thus ensure access of specific portions of data is provided to corresponding desired specific set of users. The groups may be based, for example, on the desired roles for each user.

Another aspect of the present invention ensures that the access control is provided to seamlessly enable users to access the required data while providing control according to groups. In an embodiment, a group key is designed to be decrypted using the user credentials (e.g., user identifier and password combination), which are available whenever the user attempts to access data. Thus, without additional actions being required by the user, the group key may be decrypted and used to further decrypt the data key.

Several aspects of the invention are described below with reference to examples for illustration. It should be understood that numerous specific details, relationships, and methods are set forth to provide a full understanding of the invention. One skilled in the relevant art, however, will readily recognize that the invention can be practiced without one or more of the specific details, or with other methods, etc. In other instances, well-known structures or operations are not shown in detail to avoid obscuring the features of various aspects of the present invention.

2. Example Environment

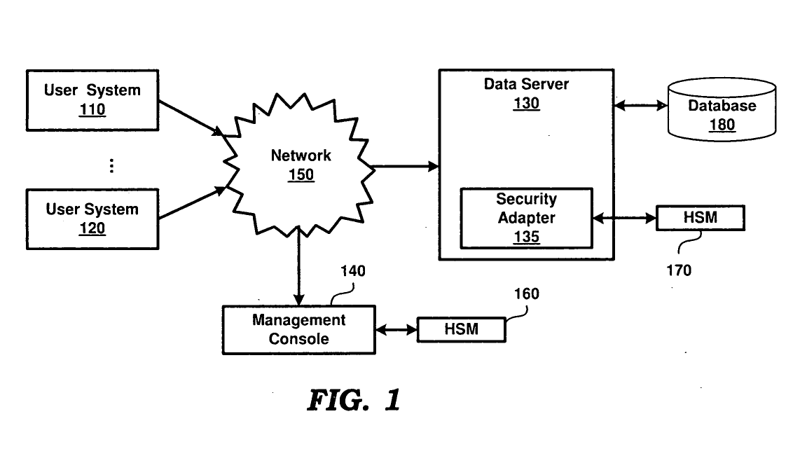

FIG. 1 illustrates an example environment in which various aspects of the present invention may be implemented. The environment is shown containing user systems 110/120, management console 140, hardware security modules (HSM) 160 and 170, network 150, data server 130, and database 180. Each block is described below in further detail.

Network 150 provides connectivity between user systems 110/120, data server 130, and management console 140. Network 150 may be implemented based on Internet Protocol (IP), in which case each connected device sends a packet with a destination IP address equaling the IP address assigned to the target device. Network 150 transports the packet to the target device. The transportation of such packets at network layer forms the basis for the user accessing the desired data portions as well as for administration of groups by administrators.

Database 180 represents an example data storage system, which stores various data portions, access to which is sought to be controlled according to several aspects of the present invention. Database 180 generally allows data to be accessed using structured queries (e.g., SQL in case of relational databases). Database 180 can store data portions I encrypted form as well as non-encrypted form, however several data portions are assumed to be stored in an encrypted form requiring a corresponding data key for decryption.

Each data portion can correspond to any part of stored data, for example, a row, column, table, specific entry identified by a single row and single column, or multiple/combination of each of these according to a pre-specified convention. It should be appreciated that data portion can be of different types, size, etc., depending on the storage system type. For example, if the data storage system simply stores a directory of files, each data unit can correspond to one or more files or folders/directories (or portions thereof).

The data key can be a private key of an asymmetric key pair, even though alternative embodiments can be implemented with other techniques (e.g., using symmetric keys). In general, in the description herein, each key is described as being according to a specific technique, other key-usage techniques can be implemented without departing from the scope and spirit of various aspects of the present invention, as will be apparent to one skilled in the relevant arts by reading the disclosure provided herein.

While database 180 stores data portions in a non-volatile (persistent) storage, alternative embodiments may be implemented in which data portions stored in voltage memory may also be protected. Also, data storage systems can be implemented using more than a single unit (here, database 180), though the description is provided with respect to a single unit here, merely for illustration. Further the unit(s) of data storage system may be connected to data server 130 by a network, though the physical connection in the Figure is shown as a point-to-point connection.

User systems 110 and 120 represent example digital processing systems (e.g., mobile phones, personal computers, etc.) from which users can access various data portions of interest. In an embodiment, it is assumed that each user provides a user identifier and password combination for authentication and then the user is permitted access to permitted data portions. For simplicity it is assumed that each user accesses the corresponding data portions of interest from a corresponding user system. However, it should be understood that typical environments would contain many users though only two users are shown in the example environment for illustration.

HSM 160 stores the private keys of respective administrators, who may specify the specific groups (or roles in the below example) to which each user belongs. A user authenticating accurately (e.g., by entering the right pass phrase or password) may thereafter have the privileges of an administrator. HSM 170 may generate the various keys (including pairs, when needed) as needed by data server 130 (described in sections below) and also store the private keys.

Management console 140 enables an administrator to specify the specific groups to which each user belongs. A suitable interface may be provided to facilitate specification of such relationships. However, management console 140 first authenticates the administrator based on the private key received from HSM 160 before permitting such specification. As an administrator specifies the relationships, the corresponding information is sent to data server 130, which adds and removes various keys, as will be clear from the description below.

Data server 130 controls access to various data portions in database according to several aspects of the present invention. While the data portions of interest may be encrypted by other systems (not shown), it is assumed that data server 130 encrypts the data portions and stores the data portions in encrypted form in database 180. Further, the each data portion is assumed to be encrypted using a public key of a corresponding key pair and that the private key of the same key pair is required for decrypting the key portion. The private key in this example is referred to as a data key. However, it is sufficient to understand that a data key is required for decrypting a corresponding key portion irrespective of the relationship with the encryption key or the specific encryption/decryption algorithms used in the cryptography approach.

Data server 130 is shown containing security adapter 135, which facilitates secure access of data portions to corresponding groups of users. The approach entails generation of various keys and HSM 170 may be used for such a purpose. HSM 170 may also provide for storage of the keys required for various description activities. The manner in which data server 130 may provide for secure access of data portions to corresponding groups of users is described below with examples. First, the description is provided with respect to various keys that may be used in an example embodiments.

3. Keys Used for Group Control and Secure Access

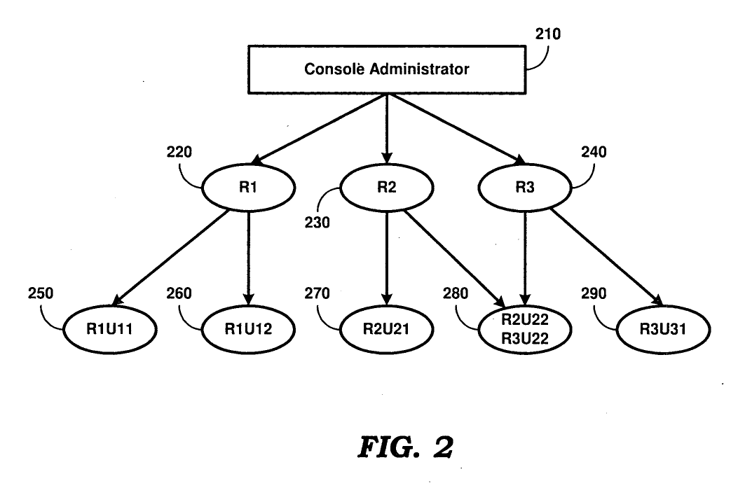

FIG. 2A depicts logically the various keys used in an embodiment of the present invention. Merely for illustration, some key types/counts are shown/described. However, various embodiments can be implemented with different types/counts of keys without departing from several aspects of the present invention, as will be apparent to one skilled in the relevant arts by reading the disclosure provided herein. Each key of FIG. 2 is described below in further detail below.

Console key 210 corresponds to the key pair that would authenticate a user. In an example scenario, console key 210 is implemented as a key pair, including a private key at management console 140 and a public key at data server 130. The user enters a pass-phrase using which the key pair was earlier generated, for example, based on RSA algorithm well known in the relevant arts. The private key authenticates the user if the value entered at management console 140 matches the pass-phrase. Once authenticated the user at management console 140 has various administrator privileges (in terms of creation of roles/groups and users and management of other private keys described below) as described below.

Role keys R1 220, R2 230 and R3 240 may each contain a key pair, and are used to identity a corresponding role. Assuming there are three groups into which users need to be categorized for corresponding access privileges for the entire data in database 180, three role pairs are shown created. For example, one group may have write/edit/modify/read privileges to all data portions, one group may have read access to only some data portions and another group may have all privileges for some other data portions. It should be appreciated that the role keys (in particular the private keys of role key pairs) represent the group keys in the present scenario. Each of roles R1, R2 and R3 is associated with a pair of keys—user public and user private keys.

Blobs 250, 260, 270, 280 and 290 are private keys of the role keys encrypted using an approach which requires the user credentials for decryption. In an embodiment, the user credentials (identifier, password, etc,) are used as a symmetric key, to encrypt and store the private keys of the role keys. Accordingly, when a user attempts to access the data portions in database 180, the user credentials may be used to decrypt the blobs and recover the role key of interest.

The manner in which the keys noted above may be managed and used is described below with examples.

4. Key Management and Use

In an embodiment, an administrator uses management Console 140 to generate and store all decryption keys as “key blobs” in a Policy Database Store in security adapter 135. As is well known, a blob generally refers to a binary long object. When key information is stored as a blob, the blob is referred to as a key blob. Key blobs can store non-key related information as well, as suited for specific environments.

In the illustrative example, there are four key attribute types in the Key management system: Administrator (210), Roles (group keys 220/230/240), Users (250/260/270/280/290) and Data Encryption Keys. The following section describes how these various keys may be generated and secured, both in software and using the optional hardware security module HSM-B 170.

Administrator: “Administrator” is the administrator of the Management Console. An Administrator has been set up in the console with a “Console Master Key Blob”. This Blob consists of a 1024 bit RSA key pair. The master key can be configured such that it is protected using either a software or hardware token (e.g., nCipher HSM). The Console enables all key management activities: generation, storage, distribution, selection, rotation, archiving and destruction of the key variables. It also defines set access privileges for these keys.

In the description below, APk represents Administrator Private key and APK the Admin Public Key.

Assuming a software key wrapping approach is used, the administrator's private key (APk may be encrypted using a passphrase (entered during authentication by the administrator), as represented by the below:

AP Blob→E(Passphrase, APk) Equation (1)

wherein AP1 represents encryption of APk using a passphrase.

In the case of Hardware key wrap, the administrator's private key may be encrypted as:

AP Blob→E(M, APk) Equation (2)

wherein M is a key generated by HSM 160.

With respect to group control, for each role, in the management console 140, administrator may create a role credential that uniquely identifies the role and its privileges (e.g., whether can read, write, modify, etc.). These credentials are signed by the Administrator's private key, accessed using either software or a hardware token (e.g., nCipher HSM). Each role is assigned a 1024 bit RSA Key pair.

Assuming RnPk is the Role Private Key and RnPK is the Role Public Key, the role private key may be encrypted using the administrator's master public key (to generate the corresponding blob Rn Blob):

Rn Blob=E(APK, RnPk) Equation (3)

wherein E(APK, RnPk] represents encryption of the role/group private key using the administrator's master public key.

The Console Administrator may map the application (database) users to one or more Roles (R). In other words, the administrator indicates the specific set of roles each user is permitted to play. Each User (U) within a role shares secret information with that role. Each user in a group has permission to gain access to the encryption key for the group private key and decrypt the data.

Thus, assuming U represents User Credentials (i.e., Name, Password hash, in an embodiment), the role private key RnPk is encrypted as follows:

Un Blob=E(Un, RnPk) Equation (5)

wherein Un Blob (user group data) represents encryption of the role private key using the user's credentials (i.e., Name, Password hash).

Thus assuming there are 5 users with a given role, the same role private key is stored in 5 separate encrypted forms as key blobs. Each of these keys has an associated access control list (ACL), indicating the set of users permitted to have the corresponding role.

With respect to data keys, assuming Cn is a data Key for a data portion of interest, in the case of Software key wrap:

Cn→D(APk, E(APK, Cn)) Equation (6)

Cn Blob=E(RnPK, Cn), wherein Cn Blob (group encrypted key) represents the encryption of the data key using the role public key.

In the case of Hardware key wrap,

Cn→D(APk, (E(APK, (E(M,Cn))) Equation (7)

Cn Blob=E(RnPK, E(M,Cn)) Equation (8)

wherein M is Module Key.

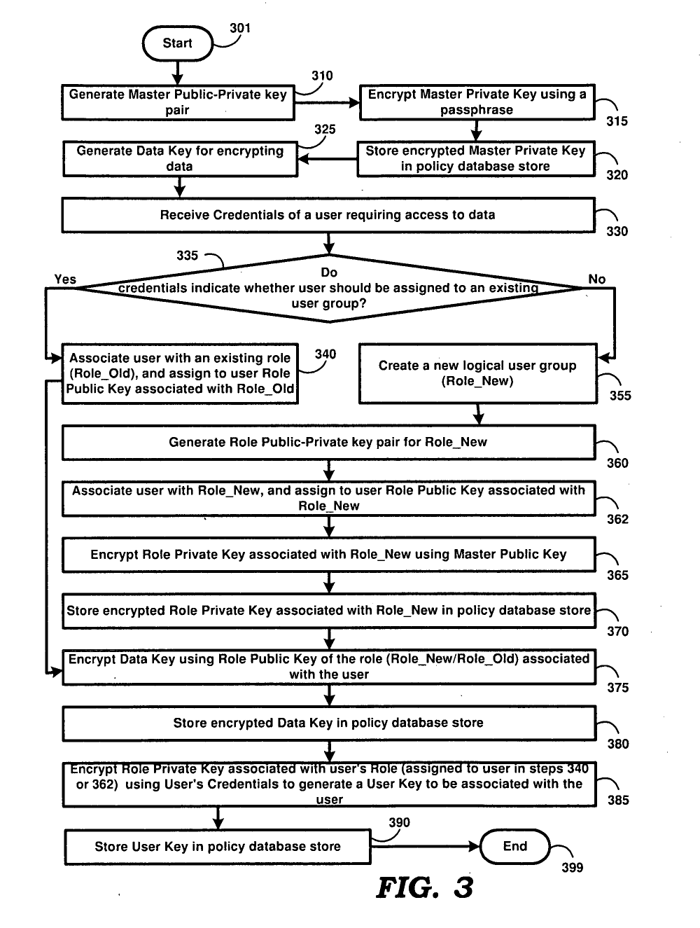

The operation of the keys will be clearer based on an understanding of the how the keys of the embodiment(s) may be used, as described below with respect to FIG. 3 below. The description there assumes that each data portion is encrypted using a public key of a key pair, and thus a corresponding private key (‘data key’) being required to decrypt the encrypted data.

5. Data Access with Group Control Access

FIG. 3 is a flow diagram illustrating the manner in which the data is accessed once the set up of all the requisite keys is complete, in an embodiment of the present invention. Login session 350 represents a scenario in which a login session is initiated by a user using user system 110. A session is established after user authenticates him/herself with the appropriate information, for example, user identifier and a password combination.

Once the user is authenticated, the user credentials are available within the data server. The user credentials generally represent any unique information/data identifying the corresponding user, and are generally provided by either the user or configured by the administrator of the system into which the user is logging in. It should be appreciated that alternative embodiments can be implemented using other unique data that identifies a corresponding user both when the user seeks access to the permitted data portions as well as when user blobs 250/260/270/280/290 are sought to be generated a priori. The manner in which access to desired data portion is provided based on the user credentials in one embodiment, is described below in further detail.

To derive the data key for encryption/decryption in software-only versions (without the use of hardware security modules):

Cn=D(D(Un, RnPk), E(RnPK, Cn)) Equation (9)

wherein D represents a decrypt operation and E an encryption operation.

This equation is shown as separate steps 350, 310-330 in FIG. 3. Broadly, E(RnPK, Cn) indicates that the encrypted data key (using the role public key) is decrypted using the decrypted private key D(Un, RnPk).

To derive the data key for encryption/decryption in Hardware-enabled versions (where hardware security modules are used), various blobs may be unwrapped as follows:

M[Cn]→D(D(Un, RnPk), E(RnPK, D(M,Cn))) Equation (10)

i.e., RnPk→D(Un, E(Un, RnPk]) Equation (11)

M[Cn]→D(RnPk, E (RnPK, E(M,Cn)) Equation (12)

Cn→D(M, M[Cn]) Equation (13)

The above equations may be summarized as follow:

When a user needs to store (and encrypt) data or read (decrypt) data, security adapter 135 transparently (without administrator's or anyone else's mediation) retrieves “role” private key of user (encrypted and stored in Policy Database Store) by decrypting the same based on the user's credentials Un. User's credentials may be obtained (block 310) from the user session—block 350 (for example, information corresponding to a database login session of the user).

Role Private key is retrieved (unwrapped) from the user credentials Un (Block 320).

RnPk→D(Un, E(Un, RnPk)), Equation (14)

wherein RnPk was earlier encrypted (and stored) using user's user name and password (credentials).

Security adapter 135 then transparently retrieves data key C, by decrypting the same using the obtained role private key (block 330):

Cn→D(RnPk, E(RnPK, Cn) Equation (15)

wherein Cn was earlier encrypted using role public key and stored.

Thus, security adapter 135 may provide data key C in a secure manner to the user.

Some of the advantages of the key management system described above may now be apparent. As may be appreciated from the above description, unwrapping (decryption) of the user key, role key, and the data key happens in a transparent manner, i.e., without the intervention of a mediator (for example, an administrator). As a result, a greater level of security may be provided to data in data server 130.

In a system, data can be accessed by various applications. Transparent access to the keys and hence the data is essential to these application to run uninterrupted. Due to transparent access no changes are required to application logic.

Another aspect of the present invention allows multiple administrators to support multiple administrators in a flexible way. In a prior solution, keys are shared between multiple administrators through different passwords or public key cryptography.

On the other hand, in the embodiments described herein, key sharing may be accomplished by generating individual administrator “Key Blobs” (ex: Role, user blobs) in a hierarchical manner such that un-wrapping a key by these administrators creates transparency to the system using this key management technique.

While the above description assumes that the keys are generally present, the description is continued with respect to the manner in which the keys are generated in an embodiment of the present invention.

6. Generation of Keys

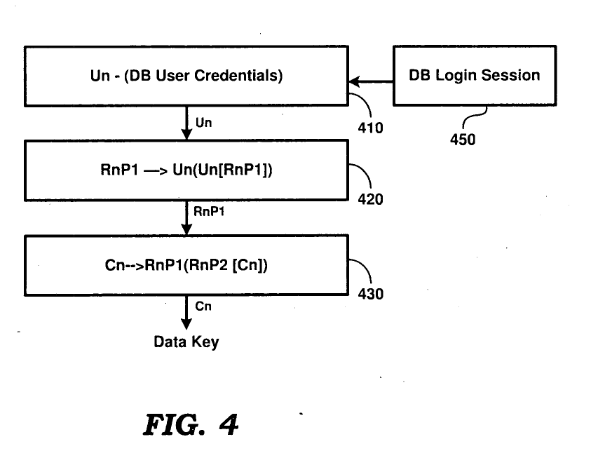

FIG. 4 is a flowchart illustrating the manner in which cryptographic keys are generated and stored in an embodiment of the present invention. The flowchart will be described with respect to the example environment of FIG. 1. The flowchart starts in step 410 in which control passes immediately to step 410.

In step 410, a master key pair containing a master private key and a master public key is generated for each role/group of interest. The key pair may be generated, for example, using the RSA algorithm. The master key pair may be used by an administrator for generating and managing the various keys according to various aspects of the present invention. Control then passes to step 415.

In step 415, the master private key (generated in step 410) is encrypted using a passphrase. Control then passes to step 420.

In step 420, the encrypted master private key is stored in a policy database store. The policy database store may be located in data server 130. Control then passes to step 425.

In step 425, data server 130 generates a data key to encrypt a corresponding data portion of interest. In an embodiment, a symmetric key approach (same key for both encryption and decryption) is used since the encryption and decryption are both performed within a controlled environment internal to an enterprise.

However, alternative embodiments can be implemented using other approaches (e.g., asymmetric keys, in which case the private key may be viewed as the data key) can be used without departing from the scope and spirit of several aspects of the present invention. Selected data in data server 130 may be encrypted by security adapter 135 using the corresponding public key generated, and the encrypted data is stored in database 180. Control then passes to step 430.

In step 430, credentials (for example, user name) of a user requiring access to data in data server 130 is received. This information may be present based on various administrator configured files. Control then passes to step 435.

In step 435, if user's credentials indicate that user may be assigned to an existing user group, control passes to step 440, else control passes to step 455.

In step 440, the user is associated with an existing user group (Role_Old), and user is assigned the role public key associated with Role_Old. As the ‘old’ group already contains the key-pair, control then passes to step 475.

In step 455, a new user group (Role_New) is created. Control then passes to step 460.

In step 460, a role public-private key pair is generated for Role_New. The key pair may be generated, for example, using the RSA algorithm. Control then passes to step 462.

In step 462, the user is associated with Role_New, and is assigned the role public key associated with Role_New. Control then passes to step 465.

In step 465, the role private key associated with Role_New is encrypted using the master public key (generated in step 410) as the key. Control then passes to step 470.

In step 470, the encrypted role private key associated with Role-New is stored in the policy database store. Control then passes to step 475.

In step 475, data key (generated in step 425) is encrypted using the role public key of the role associated with the user (Role_Old or Role_New depending on step 435). Control then passes to step 480.

In step 480, the encrypted data key is stored in the policy database store.

Control then passes to step 485.

In step 485, the role private key associated with the role (Role_Old/Role_New) assigned to the user is encrypted using the user's credentials (for example, user name, password or any other user specific information) to generate a user key to be associated with the user. Control then passes to step 490.

In step 490, the user key is stored in the policy database store. Control then passes to step 499 where the flowchart ends.

It may be seen from the description above that a user is associated with both a user key as well as a role key. As a result, secure access may be provided according to groups/roles, as described above.

7. Key Archival and Recovery

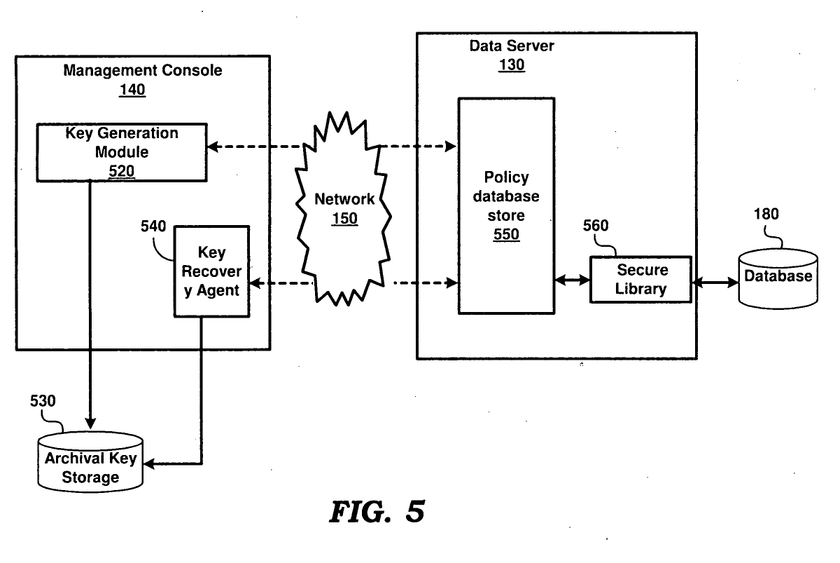

FIG. 5 is a block diagram illustrating archival and recovery of data keys in an embodiment of the present invention.

Management console 140 maintains the collection of encryption keys (generated by Key Generation Module 520 and stored in Policy Database Store 550 in data server 130) that have been archived and packaged together for backup. These keys are then stored in a separate location Archival Key storage 530, away from management console 140 and are secured with the Administrator keys (AP2 [Cn]), which can be accessed via software or a hardware token (hardware security module). This archived, encrypted information can be used for recovery in the event of lost keys.

Secure library 560 performs all the cryptographic operations related to key management and is bundled with various encryption algorithms (symmetric as well as Asymmetric)

ACn (Archived Data key) is generated by encrypting each of the data keys with the administrator's public key.

ACn Blob→E(APK, Cn) Equation (16)

Key Recovery Agent 540 facilitates recovery of encryption keys. When the encryption key is first generated, it is secured with the Administrator key. The latter acts as a Recovery Manager (RM), able to recover/decrypt encryption keys based on the Enterprise's key recovery policies.

Cn→D(APk, ACn Blob) Equation (17)

While the description of above is provided with respect to the data key merely for illustration, it should be appreciated that other encryption keys can also be secured using similar approaches. Encryption of the various keys described above may be performed using any of known methods, and is briefly noted below.

Standard cryptographic methods (e.g., FIPS approved Pseudorandom Number Generators for generating encryption data keys) and transparent key management techniques for safe and secure generation of cryptographic keys are used for encryption. Key management supports FIPS-approved encryption algorithms such as AES, 3-DES, DES and other standard algorithms such as Blowfish and Twofish.

It should be appreciated that the features described above can be implemented in a combination of one or more of hardware/software and firmware. An example embodiment in which several features of the invention are operative upon execution of the appropriate software, is briefly described below.

8. Implementation

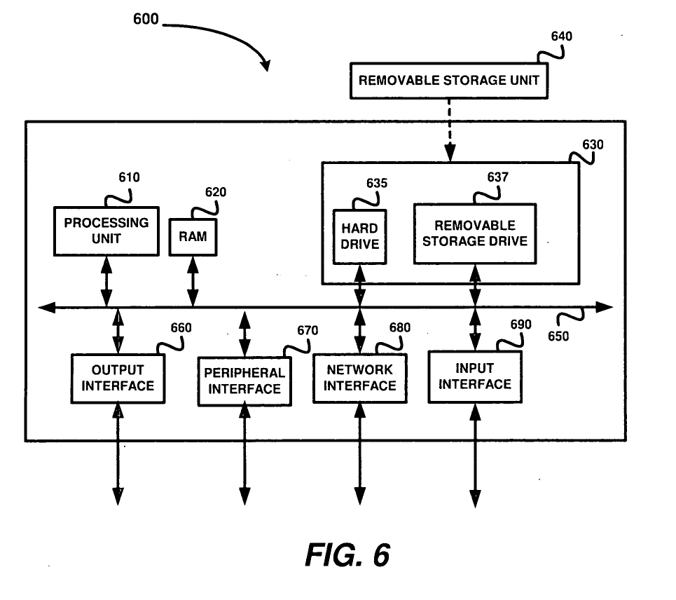

FIG. 6 is a block diagram illustrating an example embodiment of the present invention. System 600 is shown containing processing unit 610, random access memory (RAM) 620, storage 630, output interface 660, peripheral interface 670, network interface 680 and input interface 690, and may correspond to management console 140 and data server 130. Each block is described in further detail below.

Output interface 660 provides output signals (e.g., display signals to a display unit, not shown), which can form the basis for a suitable interface for an administrator (for example, generating the various keys) to interact with the system. Input interface 690 (e.g., interface with a key-board and/or mouse, not shown) enables a user/administrator to provide any necessary inputs.

Network interface 680 may enable management console 140 (as well as data server 130) to send and receive data on communication networks using ATM. Network interface 680, output interface 660 and input interface 690 may be implemented in a known way. Peripheral interface 670 may provide an interface to hardware components (such as security adapter 135, HSM-A 160, and HSM-B 170).

RAM 620, storage 630, and packet memory 670 may together be referred to as a memory. RAM 620 receives instructions and data on path 650 from storage 630, and provides the instructions to processing unit 610 for execution.

Secondary memory 630 may contain units such as hard drive 635 and removable storage drive 637. Secondary storage 630 may store the software instructions (providing various features described above) and data (the keys described above), which enable System 600 to provide several features in accordance with the present invention.

While secondary memory 630 is shown contained within system 600, an alternative embodiment may be implemented with the secondary memory implemented external to system 600, and the software instructions (described below) may be provided using network interface 680. Removable storage unit 640 may also be used to store software instructions and data, which enable System 600 to provide several features in accordance with the present invention.

Some or all of the data and instructions may be provided on removable storage unit 640 (or from a network using protocols such as Internet Protocol), and the data and instructions may be read and provided by removable storage drive 637 to processing unit 610. Floppy drive, magnetic tape drive, CD_ROM drive, DVD Drive, Flash memory, removable memory chip (PCMCIA Card, EPROM) are examples of such removable storage drive 637.

Processing unit 610 may contain one or more processors. Some of the processors can be general-purpose processors, which execute instructions provided from RAM 620. Some can be special purpose processors adapted for specific tasks (e.g., for generating keys quickly, especially if needed with quick response). The special purpose processors may also be provided instructions from RAM 620.

In general, processing unit 610 reads sequences of instructions from various types of memory medium (including RAM 620, storage 630 and removable storage unit 640), and executes the instructions to provide various features of the present invention. One of more units constituting such memory medium may be referred to as a memory, which stores one or more of the keys (encrypted as well as decrypted) described above. Such memory medium constitutes a computer readable medium from which instructions/data can be retrieved and used to provide various features described above.

Continuing with combined reference to FIG. 5, key generation module 520 may be implemented as a software module and stored in RAM 620 or secondary memory 630. Similarly key recovery agent 540, policy database store 550 and secure library 560 may also be stored in RAM 620 or secondary memory 630.

9. Conclusion

While various embodiments of the present invention have been described above, it should be understood that they have been presented by way of example only, and not limitation. Thus, the breadth and scope of the present invention should not be limited by any of the above-described embodiments, but should be defined only in accordance with the following claims and their equivalents.

What is claimed is:

1. A computer readable medium storing one or more sequences of instructions for causing a system to provide access to a plurality of data portions stored in a storage, wherein a first data portion contained in said plurality of data portions is stored in said storage in an encrypted form, wherein decryption of said first data portion in said encrypted form requires a data key, wherein execution of said one or more sequences of instructions by one or more processors contained in said network monitoring system causes said one or more processors to perform the actions of:
encrypting said data key using a group public key to form a group encrypted key, wherein a group private key and said group public key form a group key pair according to a symmetric encryption approach;
encrypting said group private key to form a user-group data, where said group private key is encrypted using an approach which requires a unique data which identifies a first user for decryption;
decrypting said user group data using said unique data to form said group private key in unencrypted form when said first user requests access to said first data portion;
decrypting said group encrypted key using said group private key to form said data key in unencrypted form; and
decrypting said first data portion in said encrypted form using said data key in unencrypted form to form said first data in unencrypted form.

2. The computer readable medium of claim 1, wherein said first data portion is encrypted using a symmetric key approach such that said data key is used for both encryption and decryption of said first data portion.

3. The computer readable medium of claim 2, wherein said unique data comprises a user credential of said first user.

4. The computer readable medium of claim 1, further comprising:
enabling an administrator to specify that a plurality of users including said first user are assigned to a group,
wherein said group private key is encrypted using a corresponding unique data for each of said plurality of users to form a plurality of user-group data including said user group data,
whereby access to said first data portion is provided only to said plurality of users in said group.

5. The computer readable medium of claim 4, wherein said administrator specifies access privileges associated with said group pair, wherein all of plurality of users are permitted said access privileges with respect to accessing said first data portion.

6. A method of providing access to a plurality of data portions, said method comprising:
storing a first data portion in an encrypted format, wherein decryption of said first data portion in said encrypted format requires a data key;
encrypting said data key using a group public key to form a group encrypted key, wherein a group private key and said group public key form a group key pair according to a symmetric encryption approach;
encrypting said group private key to form a user-group data, where said group private key is encrypted using an approach which requires a unique data which identifies a first user for decryption;
decrypting said user group data using said unique data to form said group private key in unencrypted form when said first user requests access to said first data portion;
decrypting said group encrypted key using said group private key to form said data key in unencrypted form; and
decrypting said first data portion in said encrypted form using said data key in unencrypted form to form said first data in unencrypted form.

7. The method of claim 6, wherein said first data portion is encrypted using a symmetric key approach such that said data key is used for both encryption and decryption of said first data portion.

8. The method of claim 7, wherein said unique data comprises a user credential of said first user.

9. The method of claim 6, further comprising:
enabling an administrator to specify that a plurality of users including said first user are assigned to a group,
wherein said group private key is encrypted using a corresponding unique data for each of said plurality of users to form a plurality of user-group data including said user group data,
whereby access to said first data portion is provided only to said plurality of users in said group.

10. The method of claim 9, further comprising:
encrypting one of said data key and a group key pair using a public administrator key, wherein said public administrator key and a private administrator key form an asymmetric key pair for an administrator; and
recovering said one of data key and said group key pair using said private administrator key.

11. A system comprising:
a persistent storage to store a first data portion in an encrypted format, wherein decryption of said first data portion in said encrypted format requires a data key;
a memory to store a group encrypted key and a user-group data,
wherein said group encrypted key is formed earlier by encrypting a group public key, wherein a group private key and said group public key form a group key pair according to a symmetric encryption approach,
wherein said user-group data is formed by encrypting said group private key, where said group private key is encrypted using an approach which requires a unique data which identifies a first user for decryption,
a processor operable to decrypt said user group data using said unique data to form said group private key in unencrypted form when said first user requests access to said first data portion, said processor to further decrypt said group encrypted key using said group private key to form said data key in unencrypted form, and then to decrypt said first data portion in said encrypted form using said data key in unencrypted form to form said first data in unencrypted form.
